(19) United States
(12) Patent Application Publication
(10) Pub. No.: US 2004/0094103 A1
(43) Pub. Date: May 20, 2004

(54) Radial valve gear apparatus for barrel engine

(76) Inventor: Bret R. Hauser, Flower Mound, TX (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/422,591

(22) Filed: Apr. 24, 2003

Related U.S. Application Data
(60) Provisional application No. 60/377,074, filed on Apr. 30, 2002.

(51) Int. Cl. F02B 75/18; F01L 1/26

(52) U.S. Cl. 123/56.7; 123/90.6; 123/90.22

(57) ABSTRACT

A barrel engine has an engine housing with a first and second end. An elongated power shaft is longitudinally disposed in the engine housing and defines the longitudinal axis of the engine. A plurality of cylinders surround the longitudinal axis, with each having a closed end and an open end. Each cylinder has a central axis. The open ends of the cylinders are directed toward the first end of the housing. An intake system introduces a combustible mixture of air and fuel into each of the cylinders. A track is disposed between the first end of the housing and the open ends of the cylinders such that a portion of the track is disposed generally in alignment with the central axis of each of the cylinders. The track has a cam surface that longitudinally undulates with respect to the open ends of the cylinders. A portion of the cam surface is disposed generally in alignment with the central axis of each of the cylinders. The track and the cylinders are rotatable with respect to each other such that the undulating cam surface moves with respect to the open ends of the cylinders. A piston is moveably disposed in each of the cylinders such that a combustion chamber is defined between the piston and the closed end of the cylinder. Each piston is in mechanical communication with the cam surface of the track such that as the cylinders and the track move with respect to each other, the pistons reciprocate within the cylinders. Each piston is operable to compress the combustible mixture. The power shaft has an intake lobe and an exhaust lobe extending therefrom. The intake system includes an intake valve and an exhaust valve for each of the cylinders, with the valves being linearally moveable between an open and a closed position. A valve actuation mechanism is associated with each cylinder. The mechanism includes an intake rocker arm with one end in mechanical communication with the intake lobe, the other end in mechanical communication with the intake valve, and a mid-portion that is pivotally supported. The mechanism also includes an exhaust rocker arm with one end in mechanical communication with the exhaust lobe, the other end in mechanical communication with the exhaust valve, and a mid-portion that is pivotally supported.

### CROSS-REFERENCE TO RELATED APPLICATIONS

This application claims priority to U.S. provisional patent application Serial No. 60/377,074, filed Apr. 30, 2002, the entire contents of which is incorporated herein in by reference.

### FIELD OF THE INVENTION

The present invention relates generally to internal combustion engines and, more specifically, to a valve actuation mechanism for barrel engines.

### BACKGROUND OF THE INVENTION

Barrel engine configurations, such as the general class of engines shown in U.S. Pat. No. 5,749,337 to Palatov, hold potential for high power density packages. This is desirable in many applications, particularly those requiring mobile power sources such as automotive, marine and aviation. Barrel engines typically involve a grouping of power cylinders and pistons arranged in a circle with their axes parallel to a central power shaft. The geometry of the barrel engine requires that the intake and exhaust valves be actuated in a manner that is different than traditional in-line or vee-type engines. Conventional in-line or vee-type engine configurations commonly utilize a longitudinal camshaft, parallel to the primary crankshaft that includes actuation lobes for each intake and exhaust valve or valve set per cylinder. This conventional cam is driven via gear, chain, or belt drive from the primary crankshaft with valve timing dependent upon proper assembly of the components.

A barrel engine is not well suited to use a traditional longitudinal camshaft since the intake and exhaust valves actuate in a direction that is parallel to the axis of the main power output shaft (crankshaft). Plate-style cams are often used to actuate the valves of a barrel engine. In plate cam designs, the cam is generally flat and extends perpendicularly from the main output shaft. The plate cam has a contoured surface that engages valve stems or lifters to actuate the valves, which are generally perpendicular to the plate. Although this configuration reduces parts count, there are several disadvantages. Among them are the deformation of the cam plate as a result of high force requirements to actuate the exhaust valves as compared to the stiffness of the plate and plate-to-shaft attachment. Also, the plate cam design is difficult to design such that sufficient stiffness exists without undue component weight. This is compounded as the interface to the shaft is considered. Other disadvantages include the complexity of manufacturing a plate cam to actuate the valves as compared to conventional cam grinding techniques. The ability to include hydraulic lifters or to incorporate mechanical lash adjustment is also made more complicated by a plate cam design.

### SUMMARY OF THE INVENTION

The present invention provides a barrel engine, including an engine housing having a first end and a second end. An elongated power shaft is longitudinally disposed in the engine housing and defines the longitudinal axis of the engine. A plurality of cylinders surrounds the longitudinal axis, with each cylinder having a closed end and an open end. Each cylinder has a central axis. The open ends of the cylinders are each generally directed towards the first end of the housing. An intake system is operable to introduce a combustible mixture of air and fuel into each of the cylinders. A track is disposed between the first end of the housing and the open ends of the cylinders such that a portion of the track is disposed generally in alignment with the central axis of each of the cylinders. The track has a cam surface that longitudinally undulates with respect to the open ends of the cylinders. A portion of the cam surface is disposed generally in alignment with the central axis of each of the cylinders. The track and the cylinders are rotatable with respect to each other such that the undulating cam surface moves with respect to the open ends of the cylinders. A piston is moveably disposed in each of the cylinders such that a combustion chamber is defined between the piston and the closed end of the cylinder. Each piston is in mechanical communication with the cam surface of the track such that as the cylinders and track move with respect to each other, the pistons reciprocate within the cylinders. Each piston is operable to compress the combustible mixture. The present invention provides an improvement wherein the power shaft has an intake lobe and an exhaust lobe extending therefrom. The intake system includes an intake valve and an exhaust valve for each of the cylinders. The valves are linearly moveable between an open and a closed position. A valve actuation mechanism is associated with each of the cylinders. The mechanism comprises an intake rocker arm having a first end disposed in mechanical communication with the intake lobe on the power shaft and a second end in mechanical communication with the intake valve. A mid-portion of the intake rocker arm is pivotally supported. An exhaust rocker arm has a first end disposed in mechanical communication with the exhaust lobe on the power shaft and a second end in mechanical communication with the exhaust valve. A mid-portion of the exhaust rocker arm is pivotally supported.

### BRIEF DESCRIPTION OF THE DRAWINGS

FIG. 1 is a cross-sectional view of a portion of a barrel engine showing an improved valve actuation mechanism according to the present invention.

### DETAILED DESCRIPTION OF THE PREFERRED EMBODIMENTS

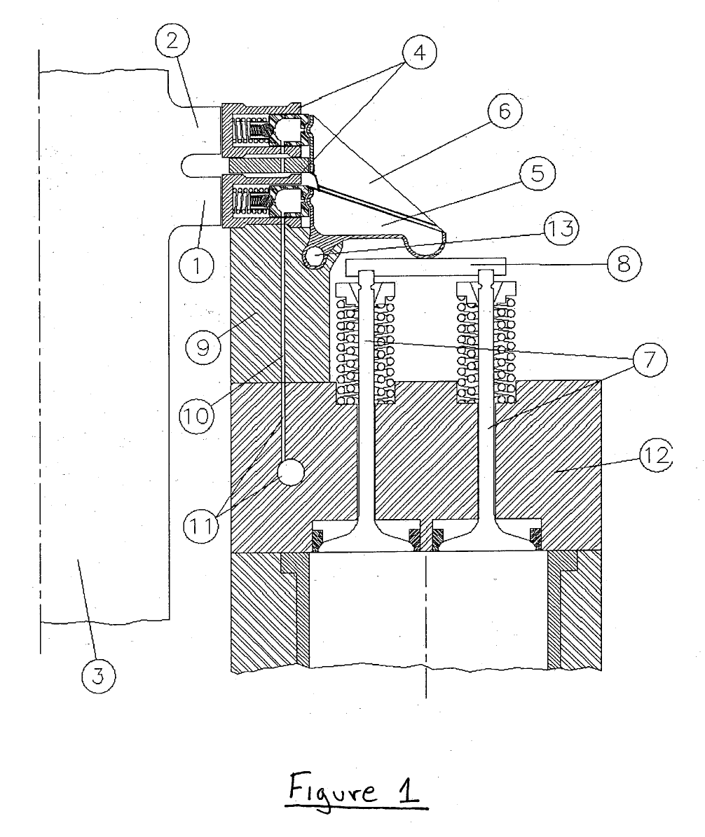

The present invention provides for an alternative method of valve actuation that allows for improved stiffness and valve gear performance, improved ease of manufacture, easy inclusion of hydraulic lifter systems or mechanical lash adjustment, and can also be used to actuate fuel injection equipment in a more conventional and simplified approach. This is accomplished through the use of “L-shaped” rocker levers arranged radially to and actuated by common cam lobes on the main output shaft. One embodiment is illustrated in FIG. 1.

As shown in FIG. 1, the main output shaft 3 in a barrel engine has intake 1 and exhaust 2 cam lobes extending generally perpendicularly therefrom. The cam lobes 1 and 2 mate with mechanical or hydraulic lifters 4 arranged perpendicular to the main output shaft in a radial fashion. The lifters in turn actuate “L-shaped” intake 5 and exhaust 6 rocker levers that in turn actuate the valves 7. FIG. 1 illustrates the intake rocker lever 5 actuating a multiple intake valve set whereas the exhaust rocker lever 6 actuates a similar multiple exhaust valve set behind (hidden). In the case of multi-valve arrangements, a crossbar 8 may be used to provide a single point of actuation from the rocker levers for the valve set. Further, a single “lifter housing” 9 provides support and guidance for all lifters (mechanical or hydraulic) as well as oil passages 10 for hydraulic lifter systems which align with oil galleries and passages 11 in the cylinder head 12. The lifter housing 9 also provides a pivot 13 for both intake 5 and exhaust 6 rockers. As configured in FIG. 1, the common pivot pin 13 and relative position of the two cam lobes 1 and 2 provide for rocker levers of differing rocker ratios or mechanical advantages. In this way, the exhaust rocker lever 6 can be designed for improved mechanical advantage resulting in reduced follower to cam contact pressures. This is beneficial because the force required to open the exhaust valve(s) is typically much greater than that for the intake valve(s) due to the pressure within the cylinder at the opening event.

FIG. 1 illustrates the intake valves 7 and intake rocker lever 5 as being disposed in a plane that is generally parallel to the plane in which the exhaust valves (hidden) and exhaust rocker lever 6 reside. As will be clear to those of skill in the art, the intake valves 7 and the intake rocker lever 5 may be canted with respect to the exhaust valves and exhaust rocker 6 so as to provide room for larger valves, a hemispherical combustion chamber or other arrangements. In these situations, the rocker arm arrangement remains generally as shown, though some modification may be required depending on the angle of the valves.

The present invention preferably provides for single cam lobes 1 and 2 to be used to actuate all valves of the same type (intake or exhaust) within the engine. For example, this configuration would provide for a single intake and single exhaust valve lobe for a six-cylinder engine as opposed to six intake and six exhaust lobes for a conventional in-line or V-type engine. Further, the single intake and exhaust lobes are arranged on the power shaft 3 in a manner conventional to traditional camshafts. Therefore, conventional manufacturing techniques can be used as opposed to the non-traditional techniques of a plate cam. This should result in reduced cost due to economies of scale. The conceived valve gear apparatus also provides for increased stiffness as compared to plate cam designs, which can result in significant overall weight savings. Although depicted and discussed here in terms of valve actuation, the present invention can also be applied to the actuation of fuel injection equipment (not shown) or other mechanisms. The cam lobes 1 and 2 as described in this invention may be either cast or forged, as part of the power shaft 3, or separately, in which case they could be either fused, splined, threaded, bolted or welded to the power shaft 3.

An alternative configuration to the one shown in FIG. 1 would utilize pushrods between the lifter 4 and rocker levers 5 and 6. Pushrods may be used simply to accommodate a gap between the placement of the rocker and lifter or to provide for the irregular placement of rockers and lifters; made necessary due to requirements for a specific rocker ratio or other geometrical constraints.

The illustrated embodiment shows a single rocker arm actuating a pair of valves using a crossbar 8. Alternatively, multiple rocker arms may be used to actuate multiple valves. For example, two intake rocker arms may be provided to actuate two intake valves independently from one another, especially for applications where the two intake valves may be phased slightly differently from one another to generate swirl or other desirable effects in the combustion chamber. The same may be provided for exhaust valve actuation. In these arrangements, where additional rockers are used, additional intake cam lobes 5 and/or multiple exhaust lobes may be provided. Additional lobes may also be provided as needed to actuate fuel injection equipment. Various types of variable valve timing designs may be also applied to the present valve actuation approach.

While only two intake and exhaust valves are shown in the illustrated embodiment, it is highly likely that some configurations will require more or fewer intake or exhaust valves than the number discussed above. Therefore, more or fewer intake and/or exhaust valves may be utilized in the present invention.

Some of the key benefits of the invention are listed as follows.

1. Intake and exhaust valve actuation, as well as fuel injector or unit pump operation for multiple cylinders can be accomplished with reduced complexity by making common use of cam profiles among the various cylinders.

2. The stiffness of the overall valve gear or fuel actuation mechanism in a barrel engine configuration is increased through the use of “L-shaped” rocker levers as opposed to a plate-type cam mounted perpendicularly to the main shaft.

3. The manufacture of valve and fuel actuation cams as an integral part of the main shaft allows for the use of conventional cam manufacturing techniques.

4. A single lifter housing allows for a compact mechanism including placement and support of the rocker levers, placement and support of the cam followers or hydraulic lifters, and lubricant oil plumbing. This housing can be assembled separately from the main engine assembly in a sub-assembly process, improving the manufacturability of this part of the engine.

5. The orientation of the cam lobe surfaces, rocker levers, and valves allow for improved mechanical advantage for the exhaust rocker where cam contact stresses are higher than for the intake due to pressures within the cylinder at the time of valve opening. This can result in reduced wear and longer service life for the exhaust valve cam as compared to conventional designs.

As will be clear to those of skill in the art, the preferred embodiments of the present invention, disclosed herein, may be altered in various ways without departing from the scope or teaching of the present invention. For example, the present invention may be combined with any of the teachings of copending U.S. patent application Ser. No. 10/021,192, filed Oct. 30, 2001, the entire contents of which are incorporated herein by reference.

I claim:

1. In a barrel engine of the type having:
an engine housing having a first end and a second end;
an elongated power shaft longitudinally disposed in the engine housing and defining a longitudinal axis of the engine;
a plurality of cylinders surrounding the longitudinal axis, each cylinder having a closed end and an open end, each cylinder having a central axis, the open ends of the cylinders each being generally directed toward the first end of the housing;
an intake system operable to introduce a combustible mixture of air and fuel into each of the cylinders;
a track disposed between the first end of the housing and the open ends of the cylinders such that a portion of the track is disposed generally in alignment with the central axis of each of the cylinders, the track having a cam surface that longitudinally undulates with respect to the open ends of the cylinders, a portion of the cam surface being disposed generally in alignment with the central axis of each of the cylinders, the track and the cylinders being rotatable with respect to each other such that the undulating cam surface moves with respect to the open ends of the cylinders; and
a piston movably disposed in each of the cylinders such that a combustion chamber is defined between the piston and the closed end of the cylinder, each piston being in mechanical communication with the cam surface of the track such that as the cylinders and track move with respect to each other, the pistons reciprocate within the cylinders, each piston being operable to compress the combustible mixture;
wherein the improvement comprises:
the power shaft having an intake lobe and an exhaust lobe extending therefrom;
the intake system including an intake valve and an exhaust valve for each of the cylinders, the valves being linearly movable between an open and closed position; and
a valve actuation mechanism associated with each cylinder, the mechanism comprising an intake rocker arm having a first end disposed in mechanical communication with the intake lobe on the power shaft, a second end in mechanical communication with the intake valve, and a midportion that is pivotally supported, the mechanism further comprising an exhaust rocker arm having a first end disposed in mechanical communication with the exhaust lobe on the power shaft, a second end in mechanical communication with the exhaust valve, and a midportion that is pivotally supported.

2. The engine according to claim 1, wherein the intake and exhaust valves move in a line that is generally parallel to the longitudinal axis of the engine.

3. The engine according to claim 1, wherein the intake and exhaust valves move in a line that is not parallel to the longitudinal axis of the engine.

4. The engine according to claim 1, wherein intake lobe and the exhaust lobe extend generally perpendicularly outwardly from the power shaft.

5. The engine according to claim 1, further comprising an intake hydraulic lifter and an exhaust hydraulic lifter each having a first and a second end, the first end of the intake hydraulic lifter being in mechanical communication with the intake lobe and the second end of the intake hydraulic lifter being in mechanical communication with the first end of the intake rocker arm, and the first end of the exhaust hydraulic lifter being in mechanical communication with the exhaust lobe and the second end of the exhaust hydraulic lifter being in mechanical communication with the first end of the exhaust rocker arm.

6. The engine according to claim 5, wherein the first end of the intake hydraulic lifter is in sliding contact with the intake lobe and the first end of the exhaust hydraulic lifter is in sliding contact with the exhaust lobe.

7. The engine according to claim 1, wherein the intake system further includes a second intake valve and a second exhaust valve, the second end of the intake rocker arm being in mechanical communication with both intake valves and the second end of the exhaust rocker arm being in mechanical communication with both exhaust valves.
